(19) United States
(12) Patent Application Publication
(10) Pub. No.: US 2011/0051433 A1
(43) Pub. Date: Mar. 3, 2011

(54) LUMINAIRE DEVICE

(76) Inventor: Yu-Che Kao, Taichung City (TW)

(21) Appl. No.: 12/549,366

(22) Filed: Aug. 28, 2009

(51) Int. Cl. F21V 21/08

(52) U.S. Cl. 362/396

(57) ABSTRACT

A luminaire device includes a guiding rail having a first electricity conducting plate and a second electricity conducting plate respectively disposed thereon, and at least one illuminating device detachably connected to the guiding rail. Each of the at least one illuminating device includes a clamp having a first clamping head and a second clamping head formed thereon. The first clamping head has a first electricity conducting unit disposed thereon. The second clamping head has a second electricity conducting unit disposed thereon. The luminaire device includes an illuminating member electrically connected to clamp. When the clamp is attached to the guiding rail, the first electricity conducting unit and the second electricity conducting unit are respectively electrically connected to the first electricity conducting plate and the second electricity conducting plate on the guiding rail, such that the illuminating member is provided electrically for illumination.

### BACKGROUND OF THE INVENTION

1. Field of the Invention

The present invention relates to a luminaire device, and more particularly to a luminaire device attached to a guiding rail.

2. Description of Related Art

A conventional flexible connecter assembly for track lighting device in accordance with the prior art comprises a first connector segment and a second connector segment. Each of the first and the second connector segment has a first end being in a plug-in type tapping mechanism for joining the connector segments mechanically and electrically to electrical distribution track sections. At least one lamp is screwedly mounted to the track sections. A flexible member is formed of a first coiled wire element and a second coiled wire element are concentrically wrapped in opposite directions with respect to each other. The first and second coiled wire elements are respectively joined at first end of the first connector segment and at second end of the second connector segment. The first and second coiled wire elements define a tubular passageway for a first and a second electrical conductor coupling the connector segments electrically, and the flexible member itself provides a ground connection between the connector segments and corresponding track sections. The construction of the flexible member permits the positioning of joined track sections at a variety of angles with respect to each other and protects the first and second electrical conductors passing therethrough between the connector segments.

Although the flexible connecter assembly for track lighting device has a flexible and expandable member permitting the positioning of joined track sections at a variety of angles, such that the track lighting device is able to be mounted to different environments. However, the at least one lamp is screwed to the track sections. The at least one lamp is not easy to detach from the track sections for maintenance. Moreover the assembly of the flexible connecter assembly for track lighting device is not simple.

The present invention has arisen to mitigate and/or obviate the disadvantages of the conventional flexible connecter assembly for track lighting device.

### SUMMARY OF THE INVENTION

The main objective of the present invention is to provide an improved luminaire device.

To achieve the objective, the luminaire device in accordance with the present invention includes at least one fixer. Each fixer has a fixing portion formed on one end thereof and a connecting portion formed on the other end thereof. The fixing portion has a threaded shaft extending therefrom for being adapted to be screwedly fixed in a ceiling or a wall. The connecting portion has a through hole defined in the lateral thereof. The through hole of the connecting portion is passed through by a guiding rail having a shape corresponding to the through hole. The guiding rail has a first groove and a second groove respectively defined along two opposite lateral sides thereof. A width of the first groove is relatively narrower than that of the second groove. A first electricity conducting plate is disposed along an inner periphery of the first groove. A second electricity conducting plate is disposed in along an inner periphery of the second groove.

The luminaire device includes at least one illuminating device detachably connected to the guiding rail. Each illuminating device includes an illuminating member for providing illumination effect. The illuminating member includes a holder connected to the clamp and at least one light source connected to the holder. The at least one light source is an arc-shaped or a U-shaped cold cathode fluorescent lamp. The at least one light source may be of any suitable type such as light emitted diodes, halogen lamps or the like. The illuminating member is electrically connected to a clamp extending therefrom.

The clamp includes a first body and a second body pivotally connected to each other. The first body and the second body are able to rotate about a pivotal axis in the middle thereof. The first body has a first clamping head and a first pressing portion respectively formed on two opposite ends thereof. The first clamping head has a first electricity conducting unit disposed on a first surface thereof. The first body includes an electric wire having two ends respectively connected to the first electricity conducting unit and the illuminating member. The first clamping head has a first protrusion extending from the first surface thereof. When the first protrusion is correspondingly engaged with the first groove of the guiding rail, the first electricity conducting unit is electrically connected to the first electricity conducting plate.

The second body has a second clamping head and a second pressing portion respectively formed on two opposite ends thereof. The second clamping head has a second electricity conducting unit disposed on a second surface thereof. The first surface and the second surface are facially arranged to each other. The second body includes a third electricity conducting unit having two ends respectively connected to the second electricity conducting unit and the illuminating member. The second clamping head has a second protrusion extending from the second surface thereof. When the second protrusion is correspondingly engaged with the second groove of the guiding rail, the second electricity conducting unit is electrically connected to the second electricity conducting plate.

The clamp further includes a resilient unit mounted between the first pressing portion and the second pressing portion. The resilient unit tends to push the first pressing portion and the second pressing portion aside, such that the first clamping head and the second clamping head are simultaneously closed together.

In accordance with another aspect of the present invention, the luminaire device further includes a jacket having an opening defined in one end thereof, such that the clamp is received in the jacket through the opening. The jacket has two slots symmetrically defined in two lateral sides thereof and adjacent to the opening for being passed through by the guiding rail.

Further benefits and advantages of the present invention will become apparent after a careful reading of the detailed description with appropriate reference to the accompanying drawings.

### BRIEF DESCRIPTION OF THE DRAWINGS

FIG. 1 is an assembly perspective view of a preferred embodiment of a luminaire device in accordance with the present invention;

FIG. 2 is a plan view of the preferred embodiment of the luminaire device in accordance with the present invention;

FIG. 3 is an exploded perspective view of the preferred embodiment of the clamp of the luminaire device in accordance with the present invention;

FIG. 4 is a perspective view of the preferred embodiment of the clamp of the luminaire device in accordance with the present invention;

FIG. 5 is a partial cross-sectional side view of the preferred embodiment of the luminaire device in accordance with the present invention as the clamp is attached to the guiding rail in a correct way;

FIG. 6 is a partial cross-sectional side view of the preferred embodiment of the luminaire device in accordance with the present invention as the clamp is attached to the guiding rail in a reverse way;

FIG. 7 is a side view of a second embodiment of the luminaire device in accordance with the present invention as the at least one light source is an arc-shaped cold cathode fluorescent lamp;

FIG. 8 is a perspective view of a third embodiment of the luminaire device in accordance with the present invention as the at least one light source is a U-shaped cold cathode fluorescent lamp;

FIG. 9 is a perspective view of a fourth embodiment of the luminaire device in accordance with the present invention as the at least one light source is three U-shaped cold cathode fluorescent lamps; and

FIGS. 10-11 are operational perspective views of a fifth embodiment of the luminaire device in accordance with the present invention as the jacket covers the clamp.

### DETAILED DESCRIPTION OF THE INVENTION

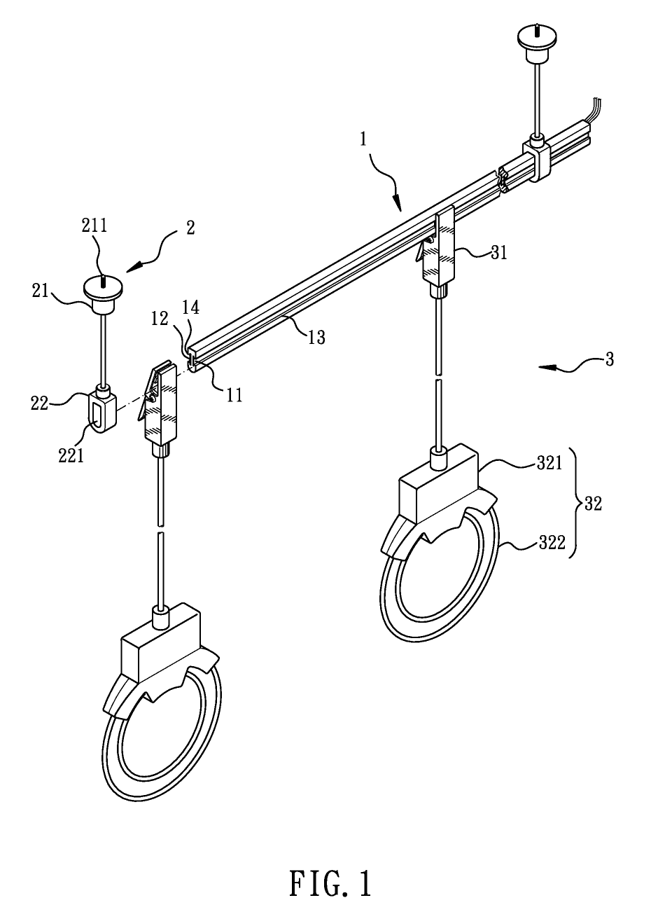

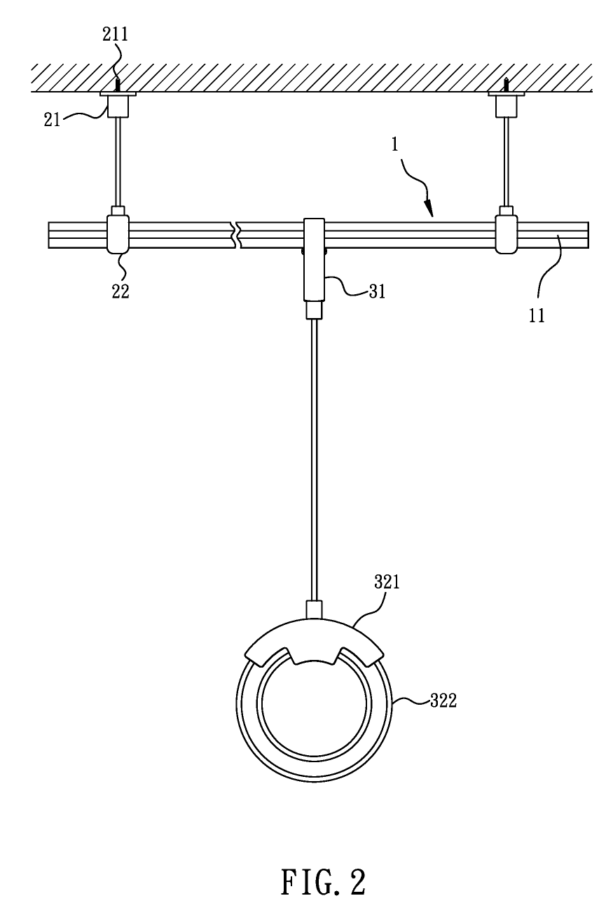

Referring to the drawings and initially to FIGS. 1-6, a luminaire device in accordance with a preferred embodiment of the present invention comprises at least one fixer 2. Each fixer 2 has a fixing portion 21 formed on one end thereof and a connecting portion 22 formed on the other end thereof. The fixing portion 21 has a threaded shaft 211 extending from one end thereof for adapting to be screwedly fixed on a ceiling or a wall. The connecting portion 22 has a through hole 221 defined in the lateral thereof. The through hole 221 of the connecting portion 22 is passed through by a guiding rail 1 having a shape corresponding to the through hole 221.

The guiding rail 1 has a first groove 13 and a second groove 14 respectively defined along two opposite lateral sides thereof. A width of the first groove 13 is relatively narrower than that of the second groove 14. A first electricity conducting plate 11 is disposed along an inner periphery of the first groove 13. A second electricity conducting plate 12 is disposed along an inner periphery of the second groove 14. The first electricity conducting plate 11 and the second electricity conducting plate 12 are adapted to be correspondingly connected to a negative electrode and a positive electrode of a power supply.

The luminaire device in accordance with a preferred embodiment of the present invention further comprises at least one illuminating device 3 detachably connected to the guiding rail 1. Each illuminating device 3 comprises an illuminating member 32 for providing illumination effect. The illuminating member 32 includes a holder 321 and at least one light source 322 mounted on one end of the holder 321 and electrically connected to the holder 321. In this embodiment, the at least one light source 322 is two arc-shaped cold cathode fluorescent lamps. The at least one light source 322 may be of any suitable type such as light emitted diodes, halogen lamps or the like. The illuminating member 32 has one end electrically connected to a clamp 31 extending therefrom.

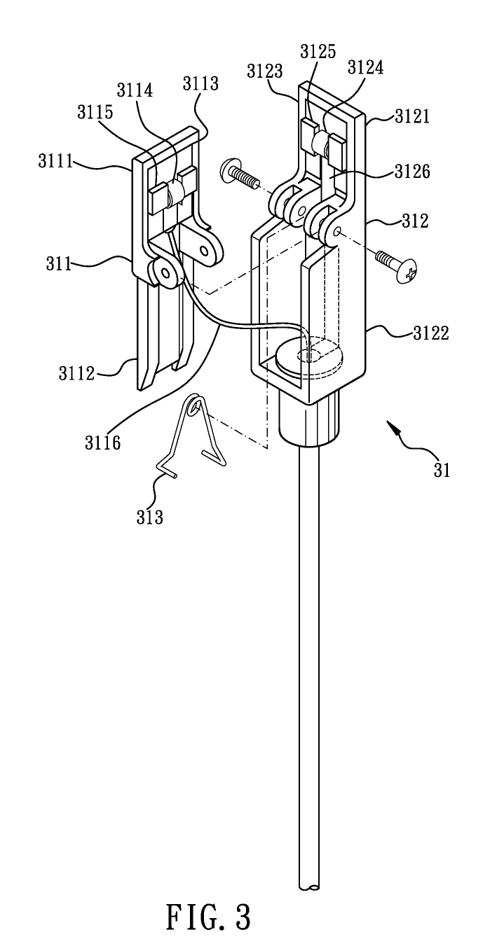

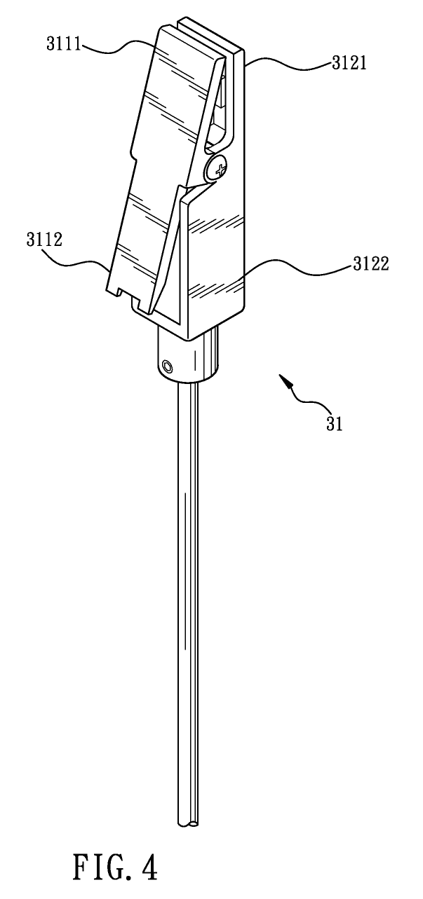

As shown in FIGS. 3 and 4, the clamp 31 includes a first body 311 and a second body 312 pivotally connected to each other. The first body 311 and the second body 312 are able to rotate about a pivotal axis in the middle thereof. The first body 311 has a first clamping head 3111 and a first pressing portion 3112 respectively formed on two opposite ends thereof. The first clamping head 3111 has a first electricity conducting unit 3114 disposed on a first surface 3113 thereof. The first body 311 includes an electric wire 3116 having two ends respectively connected to the first electricity conducting unit 3114 and the illuminating member 32. The first clamping head 3111 has a first protrusion 3115 extending from the first surface 3113 thereof and adjacent to the first electricity conducting unit 3114. The first protrusion 3115 is in a shape corresponding to the first groove 13.

The second body 312 has a second clamping head 3121 and a second pressing portion 3122 respectively formed on two opposite ends thereof. The second clamping head 3121 has a second electricity conducting unit 3124 disposed on a second surface 3123 thereof. The first surface 3113 and the second surface 3123 are facially arranged to each other. The second body 312 includes a third electricity conducting unit 3126 having two ends respectively connected to the second electricity conducting unit 3124 and the illuminating member 32. The second clamping head 3121 has a second protrusion 3125 extending from the second surface 3123 thereof and adjacent to the second electricity conducting unit 3124. The second protrusion 3125 is in a shape corresponding to the second groove 14.

The clamp 31 further includes a resilient unit 313 mounted between the first pressing portion 3112 and the second pressing portion 3122. Two ends of the resilient unit 313 respectively abuts against the first pressing portion 3112 and the second pressing portion 3122 for tending to push the first pressing portion 3112 and the second pressing portion 3122 aside, such that the first clamping head 3111 and the second clamping head 3121 are simultaneously rotated about the pivot axis to be closed together for clamping the guiding rail 1 tightly. When the first pressing portion 3112 and the second pressing portion 3122 are pressed close to each other, the first clamping head 3111 and the second clamping head 3121 are simultaneously rotated about the pivot axis, such that the clamp 31 is disengaged with the guiding rail 1. In accordance, the at least one illuminating device 3 is detachable for easy maintenance and changing an illuminated area.

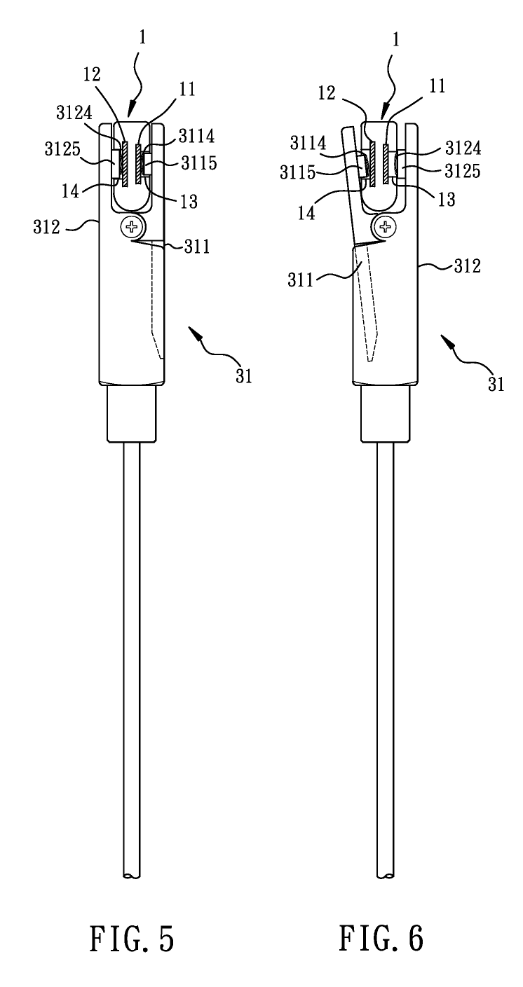

Moreover, as shown in FIG. 5, when the clamp 31 is attached to the guiding rail 1 in a correct way, the first protrusion 3115 is correspondingly engaged with the first groove 13 of the guiding rail 1, such that the first electricity conducting unit 3114 is electrically connected to the first electricity conducting plate 11. The second protrusion 3125 is correspondingly engaged with the second groove 14 of the guiding rail 1, such that the second electricity conducting unit 3124 electrically connected to the second electricity conducting plate 12. The illuminating member 32 is provided electricity through the guiding rail 1 and the clamp 31.

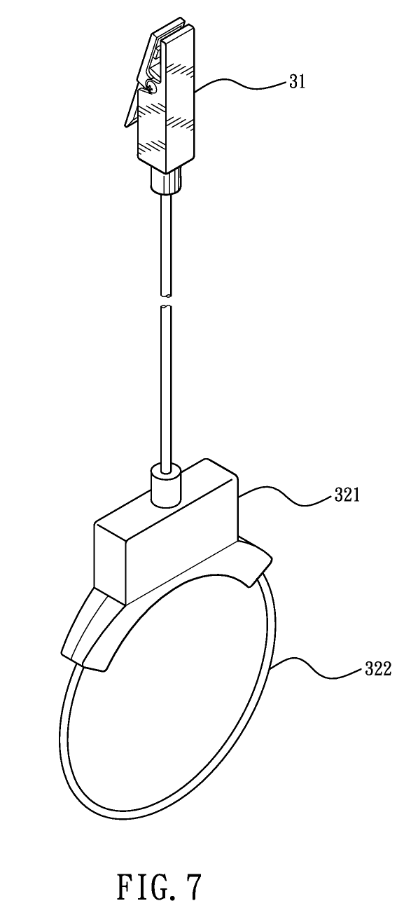

As shown in FIG. 6, when the clamp 31 is attached to the guiding rail 1 in a reverse way, the first protrusion 3115 and the second protrusion 3125 are unable to be respectively engaged with the second groove 14 and first groove 13 due to the different widths of the first groove 13 and the second groove 14. Therefore, the illuminating member 32 is unable to illuminate.

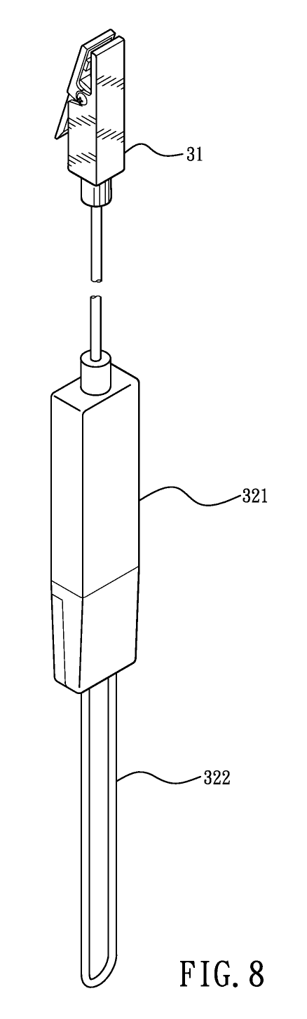

FIG. 7 shows a second embodiment of a luminaire device according to the present invention. The elements and effects of the second embodiment which are the same with the preferred embodiment are not described, only the differences are described. The at least one light source 322 is an arc-shaped cold cathode fluorescent lamp.

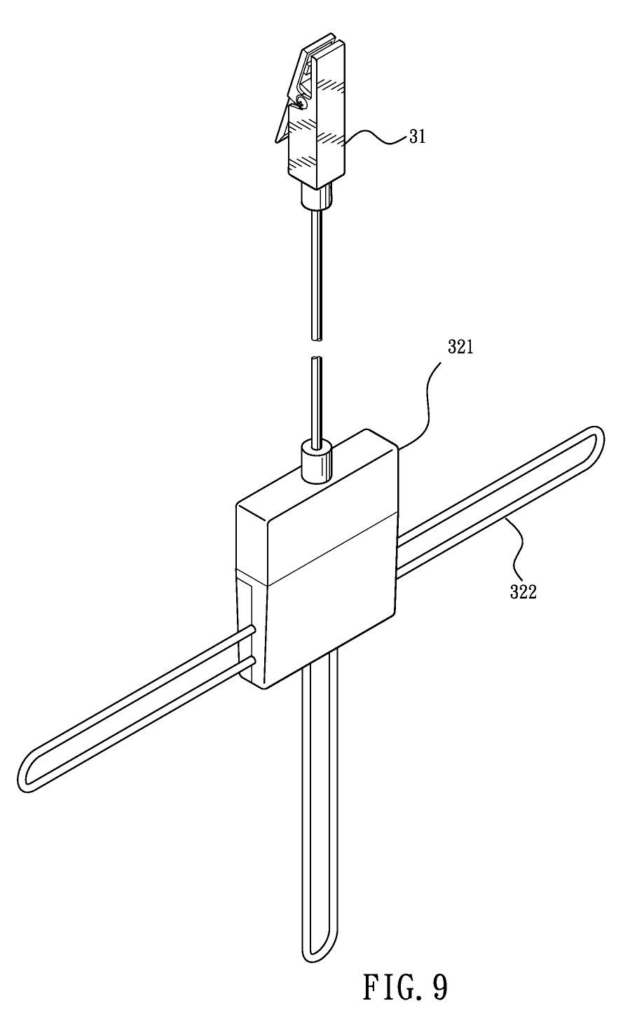

FIG. 8 shows a third embodiment of a luminaire device according to the present invention. The elements and effects of the third embodiment which are the same with the preferred embodiment are not described, only the differences are described. The at least one light source 322 is a U-shaped cold cathode fluorescent lamp.

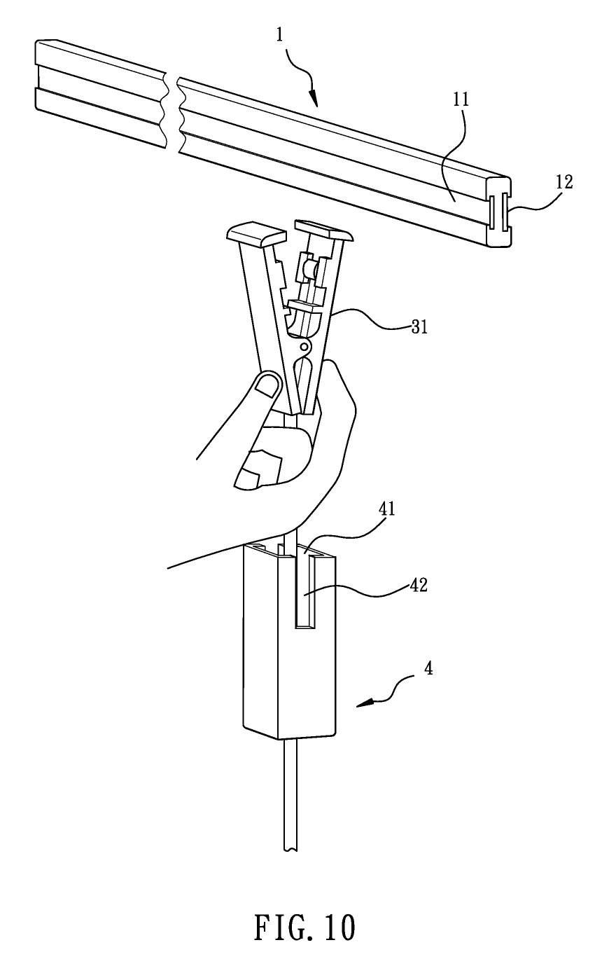

FIG. 9 shows a fourth embodiment of a luminaire device according to the present invention. The elements and effects of the fourth embodiment which are the same with the preferred embodiment are not described, only the differences are described. The at least one light source 322 is three U-shaped cold cathode fluorescent lamps. The three U-shaped cold cathode fluorescent lamps are respectively connected to the bottom and two lateral sides of the holder 321.

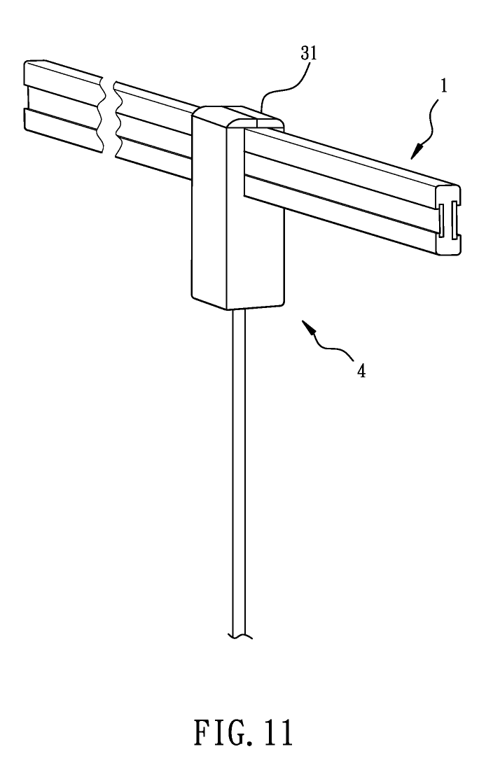

FIG. 10 shows a fifth embodiment of a luminaire device according to the present invention. The elements and effects of the fifth embodiment which are the same with the preferred embodiment are not described, only the differences are described. The luminaire device according to the present invention further comprises a jacket 4 having an opening 41 defined in one end thereof, such that the clamp 31 is received in the jacket 4 through the opening 41. The jacket 4 has two slots 42 symmetrically defined in two lateral sides thereof and adjacent to the opening 41. The two slots 42 are in a shape corresponding to the guiding rail 1. When the clamp 31 is attached to the guiding rail 1, the jacket 4 covers the clamp 31 and the guiding rail 1 passes through the two slots 42, such that the clamp 31 is protected by the jacket 4 from disengagement.

Although the invention has been explained in relation to its preferred embodiment, it is to be understood that many other possible modifications and variations can be made without departing from the spirit and scope of the invention as hereinafter claimed.

What is claimed is:

1. A luminaire device comprising:
a guiding rail having a first electricity conducting plate and a second electricity conducting plate respectively disposed along two opposite sides thereof; and
at least one illuminating device detachably connected to the guiding rail, each illuminating device comprising:
an illuminating member for providing an illumination effect;
a clamp extending from the illuminating member and electrically connected to the illuminating member, the clamp having a first clamping head and a second clamping head respectively formed thereon, the first clamping head having a first electricity conducting unit disposed on a first surface thereof, the second clamping head having a second electricity conducting unit disposed on a second surface thereof, the first surface and the second surface facially arranged to each other; and
wherein when the clamp is attached to the guiding rail, the first electricity conducting unit and the second electricity conducting unit are respectively electrically connected to the first electricity conducting plate and the second electricity conducting plate on the guiding rail, such that the illuminating member is electrically connected to the guiding rail via the clamp for providing illumination.

2. The luminaire device as claimed in claim 1, wherein the guiding rail has a first groove and a second groove defined therein, the first electricity conducting plate disposed along an inner periphery of the first groove, the second electricity conducting plate disposed along an inner periphery of the second groove, a width of the first groove being relatively narrower than that of the second groove;
the first clamping head of the clamp having a first protrusion extending from the first surface thereof for correspondingly engaging with the first groove, the second clamping head of the clamp having a second protrusion extending from the second surface thereof for correspondingly engaging with the second groove.

3. The luminaire device as claimed in claim 1 further comprising at least one fixer connected to the guiding rail, each o fixer having a fixing portion formed on one end thereof and a connecting portion formed on the other end thereof, the fixing portion having a threaded shaft extending therefrom for adapting to be screwedly fixed on a ceiling or a wall, the connecting portion having a through hole defined in the lateral thereof such that the guiding rail is connected to the fixer by passing through the through hole.

4. The luminaire device as claimed in claim 1, wherein the clamp includes a first body and a second body pivotally connected to each other, the first body having the first clamping head and a first pressing portion respectively formed on two opposite ends thereof, the second body having the second clamping head and a second pressing portion respectively formed on two opposite ends thereof, the clamp including a resilient unit mounted between the first body and the second body for pushing the first pressing portion and the second pressing portion aside such that the first clamping head and the second clamping head are simultaneously closed together.

5. The luminaire device as claimed in claim 4, wherein the first body includes an electric wire having two ends respectively connected to the first electricity conducting unit and the illuminating member, the second body including a third electricity conducting unit having two ends respectively connected to the second electricity conducting unit and the illuminating member.

6. The luminaire device as claimed in claim 1, wherein the illuminating member includes a holder connected to the clamp and at least one light source connected to the holder, the at least one light source being an arc-shaped cold cathode fluorescent lamp.

7. The luminaire device as claimed in claim 1, wherein the illuminating member includes a holder connected to the clamp and at least one light source connected to the holder, the at least one light source being a U-shaped cold cathode fluorescent lamp.

8. The luminaire device as claimed in claim 1 further comprising a jacket having an opening defined in one end thereof such that the clamp is received in the jacket through the opening, the jacket having two slots symmetrically defined in two lateral sides thereof and adjacent to the opening for being passed through by the guiding rail.
